(19) United States
(12) Patent Application Publication
(10) Pub. No.: US 2013/0006667 A1
(43) Pub. Date: Jan. 3, 2013

(54) MOBILE INTERFACE FOR INTEGRATED MEDICAL SOFTWARE SYSTEM

(76) Inventors: W. Thomas GREEN, III, Carrollton, GA (US); James T. Ingram, Carrollton, GA (US); Johnathan Samples, Carrollton, GA (US); Gregory H. Schulenburg, Carrollton, GA (US); Antonio Gerena, Villa Rica, GA (US)

(21) Appl. No.: 13/493,165

(22) Filed: Jun. 11, 2012

Related U.S. Application Data
(60) Provisional application No. 61/495,823, filed on Jun. 10, 2011.

(51) Int. Cl. G06Q 50/24

(52) U.S. Cl. 705/3

(57) ABSTRACT

The present invention allows a physician to interact with an integrated medical software system, using a handheld device such as an iPhone, iPad, or iPod Touch. A physician can log on using the handheld device and access the system to view and edit data.

### REFERENCE TO RELATED APPLICATION

The present application claims the benefit of U.S. Provisional Patent Application No. 61/495,823, filed Jun. 10, 2011, whose disclosure is hereby incorporated by reference in its entirety into the present disclosure.

### FIELD OF THE INVENTION

The present invention is directed to a mobile interface for an integrated medical software system.

### DESCRIPTION OF RELATED ART

U.S. Patent Application Publication No. US 2011/0202370 A1, whose disclosure is hereby incorporated by reference in its entirety into the present disclosure, teaches an integrated medical software system with embedded transcription functionality, and a method of using that system. The system includes a clinical software module that is configured to be executed by a processor to create an electronic document and to capture clinical data for a patient in the electronic document during an encounter with the patient. The system also includes a transcription software application that is configured to be executed by the processor to select predefined clinical data that will appear within the electronic document in response to speech commands and to automatically transcribe dictated clinical data that will appear within the electronic document in response to dictation, wherein the predefined clinical data being previously linked to at least one of a diagnosis code and a procedure code and the dictated clinical data being automatically linked to at least one of a diagnosis code and a procedure code as it is transcribed. And the system includes an account management software module that is configured to be executed by the processor to automatically generate at least one of a bill, a claim, or a statement for the patient using the at least one of a diagnosis code and a procedure code linked to at least one of the predefined clinical data and the dictated clinical data.

However, no technique for accessing that system from a mobile device is disclosed.

### SUMMARY OF THE INVENTION

It is therefore an object of the invention to provide such mobile access.

To achieve the above and other objects, the present invention is directed to a system and method for accessing the above-noted system through a handheld device such as smartphone or tablet computer.

The preferred embodiment is contemplated for use with Apple products running iOS, such as the iPhone, iPod Touch, and iPad, although the invention can be adapted for any mobile operating system, such as Android. Also, the mobile interface can communicate with the integrated medical software system in any suitable manner, such as WiFi or 3G or 4G cellular data. Therefore, references to specific hardware and software should be construed as illustrative rather than limiting.

### BRIEF DESCRIPTION OF THE DRAWINGS

A preferred embodiment will be set forth in detail with reference to the drawings, in which:

FIG. 1 is a screen shot showing a settings page;

FIG. 2 is a screen shot showing a trial page;

FIG. 3 is a screen shot showing a login page;

FIG. 4 is a screen shot showing an appointment list;

FIG. 5 is a screen shot showing a screen for adding a patient;

FIG. 6 is a screen shot showing a list of recent patients;

FIG. 7 is a screen shot showing a search page;

FIG. 8 is a screen shot showing a summary of a patient's chart;

FIG. 9 is a flow chart showing the use of the preferred embodiment; and

FIG. 10 is a block diagram showing the interaction among the various hardware components.

### DETAILED DESCRIPTION OF THE PREFERRED EMBODIMENT

A preferred embodiment will be set forth with reference to the drawings, in which like reference numerals refer to like elements or steps throughout.

The preferred embodiment allows remote, two-way integration of complete ambulatory and hospital-based patient data housed in Greenway's PrimeSUITE electronic health record. The paperless technology provides patient history and Problem lists, progress notes and appointment schedules encompassing a healthcare providers' entire patient population. As well as providing clinical tools such as viewing lab results, PrimeMOBILE also integrates patient billing and charge capture which assures proper claims and the financial health of a practice. Accessed by a simple login, providers can view patient notes and search individual patient records.

Through PrimeMOBILE, physicians in all specialties and subspecialties can practice sound medicine- and communicate with peers and patients-from any remote location.

When you download PrimeMOBILE you can use the trial database by clicking the trial button on the login screen.

Functionality includes:
View Appointment list
View Recent patient list
Search for patients
Add new patient
View Patient Facesheet
Edit patient Facesheet sections
Patient info
Vitals
Past medical History
Past surgical History
Allergies
Family Medical History
Genetic Screening
Menstrual History
Social History
Problem List
View Patient Documents
View Patient Inbound charge
Add new Inbound charge
Edit existing Inbound Charge

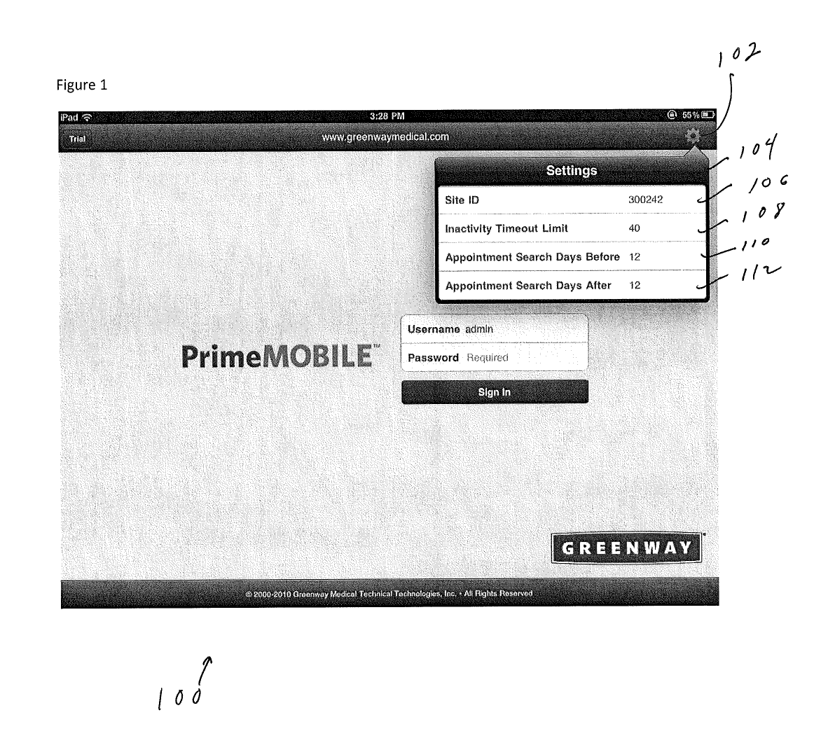

FIG. 1 shows the settings page 100, which is the login page as seen for the first time. Touching a settings icon 102 brings up a settings menu 104, which includes entries for a site ID 106, an inactivity timeout limit 108, and limits 110, 112 on the date range to search for appointments. The site ID number (same as Practice Site # which can be obtained from their Office administrator and/or Account Management Representative) must be entered to access the correct PrimeSuite system. This is a onetime application setting. The appointment search days should also be configured appropriately in order to view the desired patients. Once this is complete, select the “Done” button to return to the “Login” Page. It is important to note that currently only 100 patients will be returned based on the information entered on the settings page, although that will not necessarily be true of all conceivable embodiments.

From the Trial page or the Login Page the user must select the Settings Icon at the top right corner of the page. The user will then be navigated to this page where he/she may enter the Site ID as well as the appointment search days.

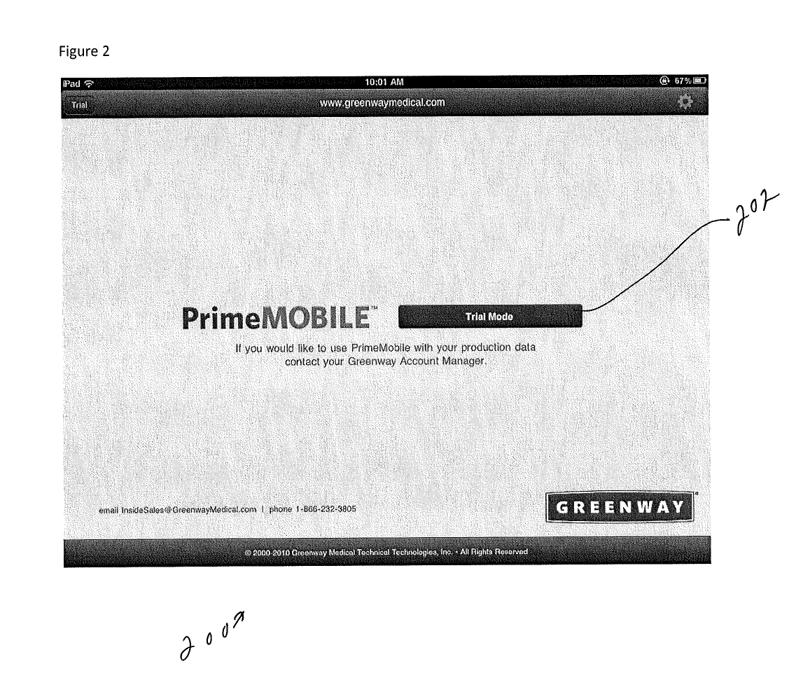

The trial page, shown in FIG. 2 as 200, offers you the option to select the Trial Mode or to contact Account Management. You may select the Trial button 202 if you wish to view a demo of the application. The trial version is associated with a demo server located at Greenway. The demo server does not contain real patient data but it is a true replica of the functionality you will see with the production application. If you wish to activate your site's PrimeMOBILE account you may call or email your account representative. This is done by calling the phone number or the Email address from the screen.

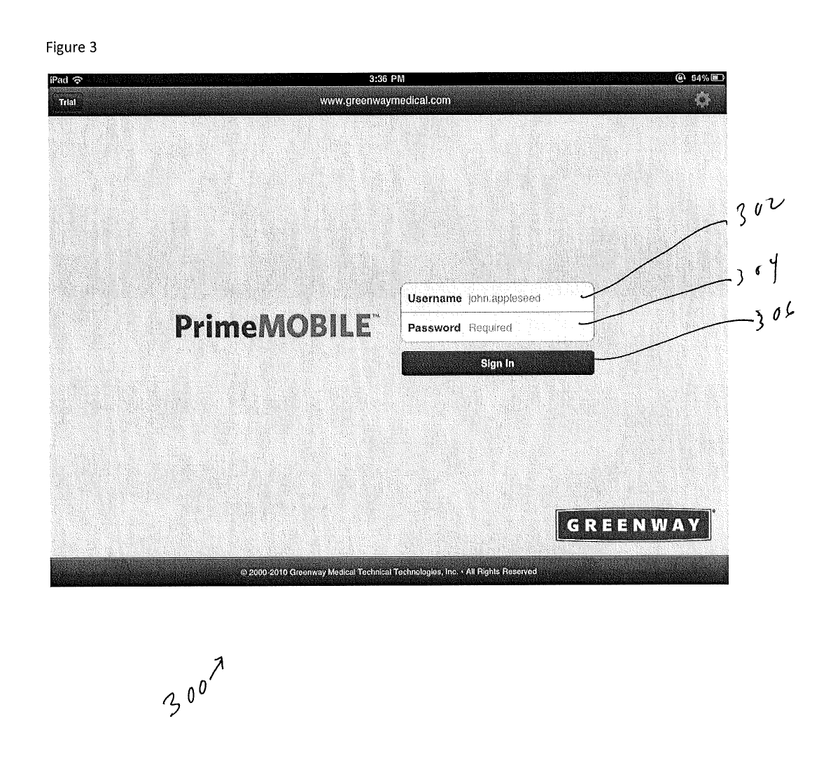

Once the Settings page has been configured, the app will default to the login page as shown in FIG. 3. The user will enter his/her PrimeSuite username and password in the areas 302 and 304 and click the “Sign In” button 306.

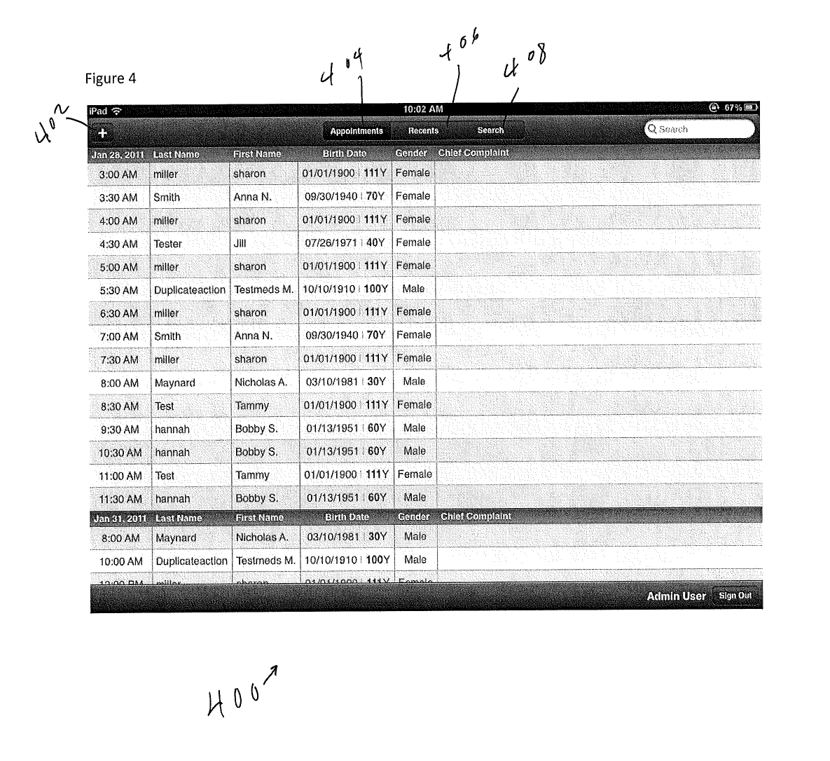

The appointment list, shown in FIG. 4 as 400, then appears. The appointment list 400 is designed to give the user a view of his/her appointments for the specified time range. The user may customize the appointment date range from the settings tab located in the upper right hand corner of the Login page. You can also add a new patient from this screen by selecting the “+” Button 402 in the top Left corner. The screen also has an “Appointments” button 404, a “Recents” button 406, and a “Search” button 408 to switch among views of appointments, recently viewed patients, and a search function to search for patients.

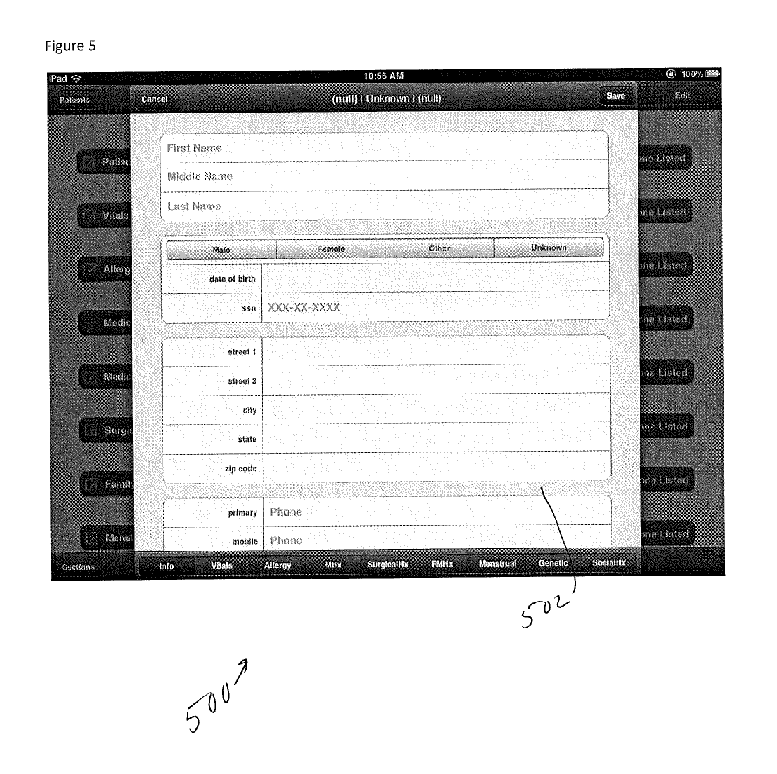

FIG. 5 shows the “Add a new patient” screen 500 that then appears. The screen includes fields 502 for entry of appropriate information regarding the new patient.

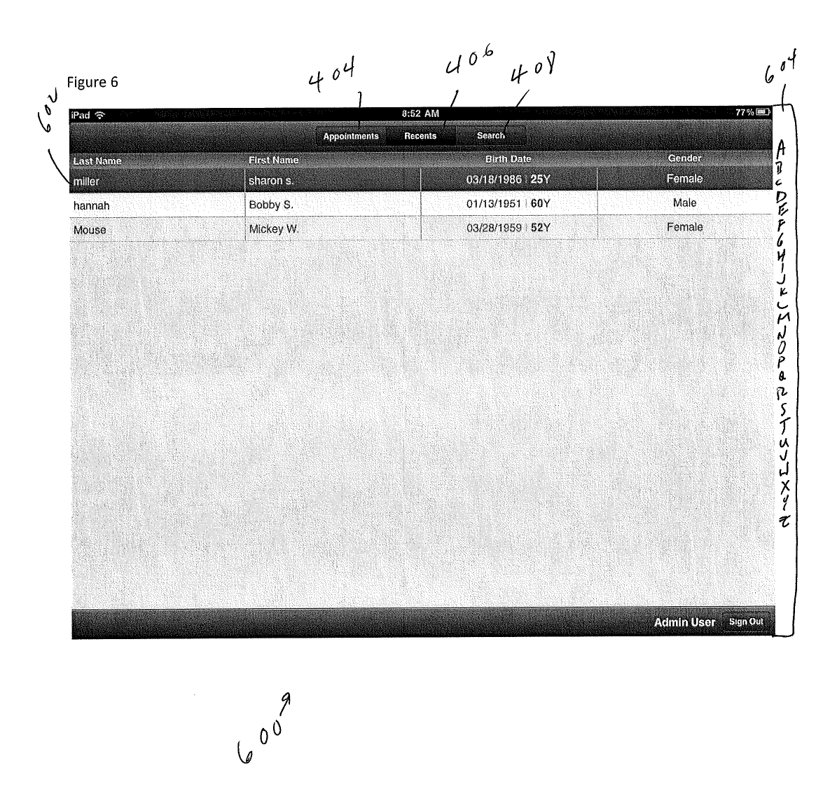

The recent patient list 600 of FIG. 6 displays a list 602 of all patients that have been recently accessed in alphabetical order by their last name. The user can select a patient to view the patient summary. The user may select the individual letter listed in the area 604 on the right side of the screen that the patient's last name starts with to skip straight to the letter. The user also has the option of entering the patient's name into the Filter list to help locate a specific patient.

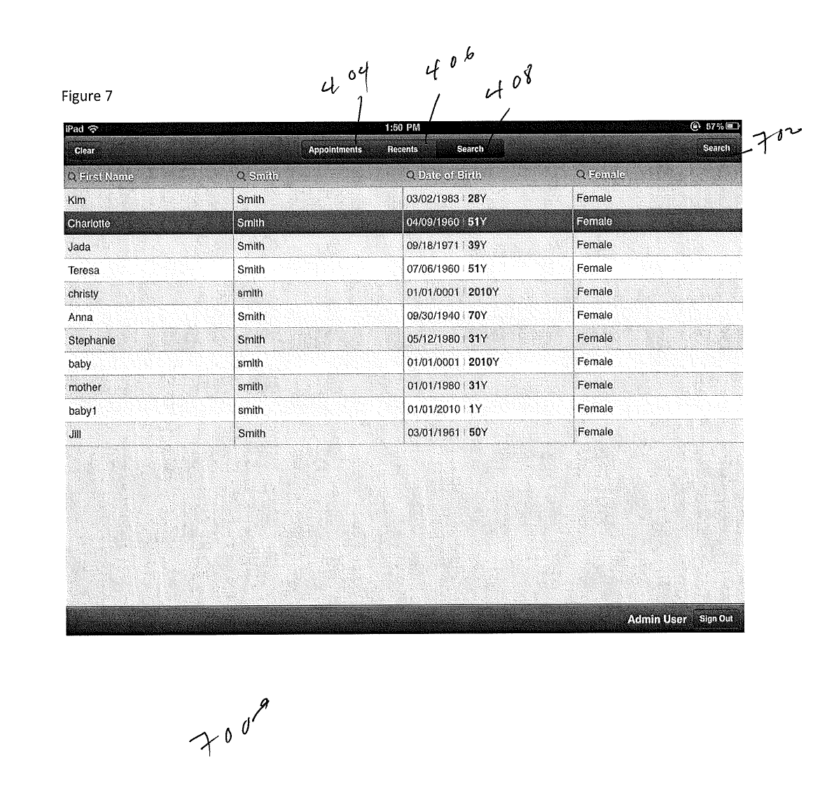

Clicking on the “Search” button 408 calls up the patient search screen 700 of FIG. 7. From the patient search screen, the user may select to Add Search Criteria or subtract a filter when searching for patients. Once the user has chosen which field(s) to search by, the user must press the Search for Patients button 702. Upon clicking the Search for Patient button the user will be navigated to the Patient Search Results page.

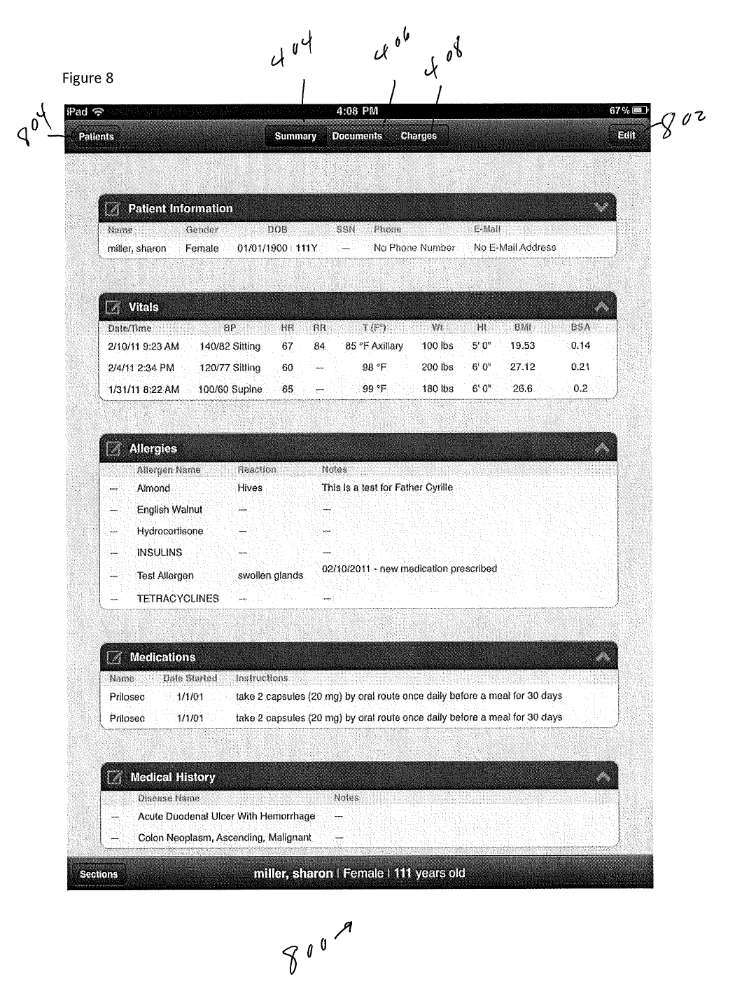

By selecting a patient, the user may access a summary of the entire patient chart, as shown in FIG. 8 as 800. Some sections will have the option to edit the document. These editable sections will be accessed by the Edit button 802 in the upper right hand corner. The user can also return to the list of patients by using the “Patients” button 804.

The user can also look up and, as appropriate, edit specific details about each patient, such as:

Allergy list

Family Medical History

Genetic Screening

Past Surgical History

Past Medical History

Problem List

Social History

Medication list

Vital Signs

Pregnancy Details

Pregnancy Summary

Menstrual history

Patient info (demographics)

Patient Document List

Charge History

Add New Charge

View charge details

Edit Charges Submissions

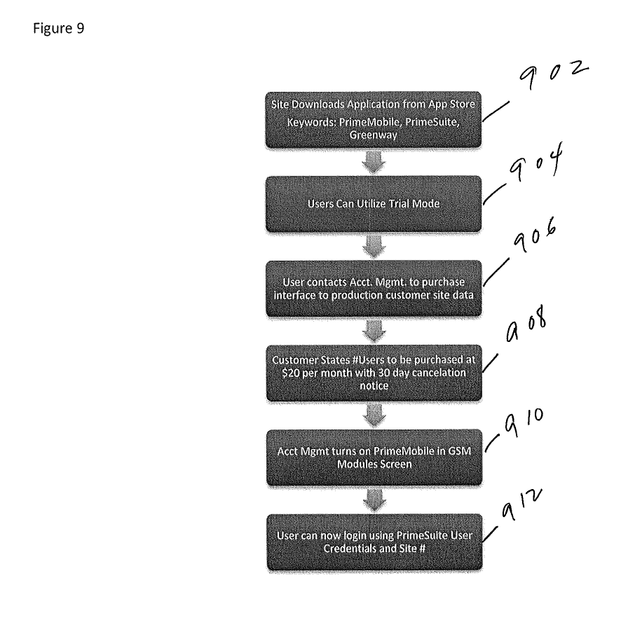

FIG. 9 shows a flow chart of the use of the preferred embodiment. In step 902, the user searches the application store for the application and downloads it to the user's device. In step 904, the user can use the application in trial mode, as explained above. In step 906, the user contacts account management to purchase access. In step 908, the customer states the number of users for which access is to be purchased. In step 910, account management provides the access. In step 912, the user can log in.

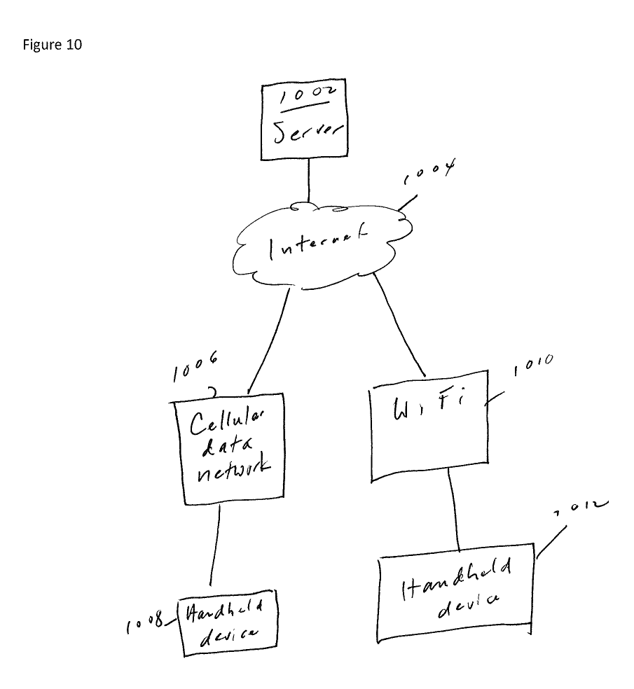

FIG. 10 shows the interaction among the various hardware components. The integrated medical software system resides on a server 1002 in communication with the Internet 1004 or another suitable communication network. Communication can proceed over a cellular data network 1006 (which may be 3G WCDMA, GD EV-DO, HSPA+, LTE, WiMAX, or any other suitable network) to a handheld device 1008. Communication can also proceed over a WiFi network to another handheld device 1012.

While a preferred embodiment has been set forth above, those skilled in the art who have reviewed the present disclosure will readily appreciate that other embodiments can be realized within the scope of the invention. For example, the appearances of the various screens are illustrative rather than limiting, as are the specifics of the information that a user is allowed to view and edit and the recitations of specific numerical values and technologies. Therefore, the present invention should be construed as limited only by the appended claims.

We claim:

1. A device for mobile interaction with an integrated medical software system with embedded transcription functionality, the integrated medical software system comprising:
a clinical software module that is configured to be executed by a processor to create an electronic document and to capture clinical data for a patient in the electronic document during an encounter with the patient;
a transcription software application that is configured to be executed by the processor to select predefined clinical data that will appear within the electronic document in response to speech commands and to automatically transcribe dictated clinical data that will appear within the electronic document in response to dictation, the predefined clinical data being previously linked to at least one of a diagnosis code and a procedure code and the dictated clinical data being automatically linked to at least one of a diagnosis code and a procedure code as it is transcribed; and
an account management software module that is configured to be executed by the processor to automatically generate at least one of a bill, a claim, or a statement for the patient using the at least one of a diagnosis code and a procedure code linked to at least one of the predefined clinical data and the dictated clinical data;
the device comprising:
a handheld computing device having a processor and a memory; and
code stored in the memory, the code, when executed on the processor, controlling the handheld computing device to interact with the integrated medical software system.

2. The device of claim 1, wherein the handheld computing device comprises one of a mobile telephone and a tablet computer.

3. The device of claim 1, wherein the handheld computing device comprises a device running iOS.

4. The device of claim 1, wherein the code comprises code for implementing a trial database.

5. The device of claim 1, wherein the code comprises code for implementing a login screen.

6. The device of claim 5, wherein the code further comprises code for allowing a user to enter a site identification code identifying the integrated medical software system.

7. The device of claim 6, wherein the code is configured for one-time entry of the site identification code.

8. The device of claim 1, wherein the code comprises code for receiving an entry of a range of dates for searching appointments stored in the integrated medical software system.

9. The device of claim 1, wherein the code comprises code for receiving an entry of an inactivity timeout limit.

10. The device of claim 1, wherein the code comprises code for receiving an entry of a new patient to be added to the integrated medical software system.

11. The device of claim 1, wherein the code comprises code for permitting a search for a patient in the integrated medical software system.

12. The device of claim 11, wherein the code further comprises code for displaying information concerning the patient.

13. The device of claim 12, wherein the code further comprises code for changing the information concerning the patient and for adding additional information concerning the patient.

14. The device of claim 1, wherein the handheld computing device comprises a communication component for communicating wirelessly with the integrated medical software system.

15. A method for mobile interaction with an integrated medical software system with embedded transcription functionality, the integrated medical software system comprising:
a clinical software module that is configured to be executed by a processor to create an electronic document and to capture clinical data for a patient in the electronic document during an encounter with the patient;
a transcription software application that is configured to be executed by the processor to select predefined clinical data that will appear within the electronic document in response to speech commands and to automatically transcribe dictated clinical data that will appear within the electronic document in response to dictation, the predefined clinical data being previously linked to at least one of a diagnosis code and a procedure code and the dictated clinical data being automatically linked to at least one of a diagnosis code and a procedure code as it is transcribed; and
an account management software module that is configured to be executed by the processor to automatically generate at least one of a bill, a claim, or a statement for the patient using the at least one of a diagnosis code and a procedure code linked to at least one of the predefined clinical data and the dictated clinical data;
the method comprising:
(a) connecting to the a handheld computing device having a processor and a memory; and
(b) controlling the handheld computing device to interact with the integrated medical software system.

16. The method of claim 15, wherein the handheld computing device comprises one of a mobile telephone and a tablet computer.

17. The method of claim 15, wherein the handheld computing device comprises a device running iOS.

18. The method of claim 15, further comprising implementing a trial database in the handheld computing device.

19. The method of claim 15, wherein step (b) comprises implementing a login screen.

20. The method of claim 19, wherein step (b) further comprises allowing a user to enter a site identification code identifying the integrated medical software system.

21. The method of claim 20, wherein step (b) comprises allowing one-time entry of the site identification code.

22. The method of claim 15, wherein step (b) comprises receiving an entry of a range of dates for searching appointments stored in the integrated medical software system.

23. The method of claim 15, wherein step (b) comprises receiving an entry of an inactivity timeout limit.

24. The method of claim 15, wherein step (b) comprises receiving an entry of a new patient to be added to the integrated medical software system.

25. The method of claim 15, wherein step (b) comprises permitting a search for a patient in the integrated medical software system.

26. The method of claim 25, wherein step (b) further comprises displaying information concerning the patient.

27. The method of claim 26, wherein step (b) further comprises changing the information concerning the patient and for adding additional information concerning the patient.

28. The method of claim 15, wherein step (a) is performed wirelessly.
